(19) United States
(12) Patent Application Publication
(10) Pub. No.: US 2002/0081154 A1
(43) Pub. Date: Jun. 27, 2002

(54) Underground pipe bursting head

(76) Inventors: Rod Herrick, San Jose, CA (US); Billy Don Pack SR., Exeter, CA (US)

Correspondence Address: Falk & Fish, POST OFFICE BOX 2258, Morgan Hill, CA, 95038, US

(21) Appl. No.: 09/748,824

(22) Filed: Dec. 26, 2000

(51) Int. Cl. F16L 1/00

(52) U.S. Cl. 405/184

(57) ABSTRACT

Several new bursting head designs and several hydraulic pulling arrangements for pulling such bursting heads through underground pipe for replacement of such pipes are disclosed. The new bursting head design utilizes a point of attachment inside the bursting head instead of at a clevis or pin on a bar extending out from the nose. The bursting head also uses a more shallow slope for the bursting head, and Chinese handcuff type cable and replacement pipe clamping mechanisms.

### FIELD OF USE

The invention finds applicability in the field of systems to replace old underground pipe by drawing a bursting head through the old pipe to burst it and pulling a new pipe through behind the bursting head.

### BACKGROUND OF THE INVENTION

In service after many years underground pipes such as sewer pipes, water pipes or other types of pipes become either clogged, narrowed or otherwise unsuitable.

The first attempts to replace such pipes required digging the entire pipe up and replacing it. That was too much digging.

Later, bursting heads were developed which could be hydraulically pulled through the old pipe to burst it. These bursting heads had conical shapes with a minimum diameter that fit inside the pipe but a maximum diameter which exceeded the diameter of the pipe. The prior art bursting heads also had fins which were sharp and concentrated stress at one location on the inside of the cement or tile pipe to encourage it to fracture as the bursting head was pulled through the pipe. These prior art bursting heads had plastic extensions coupled to the back of the bursting head which were welded to plastic replacement pipes so that as the old pipe was destroyed, the new pipe would be pulled in behind the bursting pipe.

U.S. Pat. No. 5,816,745 to Tenbusch, II describes a hydraulic jack system that pushes new sections of pipe which in turn push a sleeve-cone expander arrangement that breaks up the old pipe to make a path for the new pipe that is pushing the burster head.

A prior art bursting head arrangement and method of trenchless pipe replacement is also taught in U.S. Pat. No. 5,785,458 to Handford. This patent teaches moving a pipe removing tool 70 along the existing pipe 44 to remove it and dragging a new pipe behind the pipe removing tool while imparting a vibratory motion to the tool or continuously applying dressing material ahead of the new pipe to act as a lubricant or to fill the space between the new pipe and the surrounding soil. This patent also teaches pipe removing tools in the form of bursting heads which fracture the old pipe.

U.S. Pat. No. 5,628,585 to Parish, II et al. teaches a method for removing an old pipe by pulling a rotating head to remove old concrete or tile pipe by cutting, chipping and grinding. A new polyolefin pipe is pulled into the hole created by removal of the old pipe behind the rotating head. The rotating head has an outer periphery of roller bits which cut, chip and grind the old pipe.

U.S. Pat. No. 5,482,404 to Tenbusch II teaches a stationary hydraulic jack which pushes section of new pipe which in turn push a frontal code expander to break up the old pipe.

U.S. Pat. No. 5,328,297 to Handford teaches trenchless replacement of an old pipe using a frame section 12 located above a service pit which exposes one end of the old pipe. An extendable leg of the frame extends into the service pit. A support member 18 provided on the leg member support the leg against the inside of the service pit. A cable guide 16 located on the leg 14 guides a pulling cable extending through the old pipe. A winch on the frame above the service pit pulls on the pulling cable. This vertical pull on the pulling cable allows a smaller service or pulling pit to be dug, but the pulley or cable guide which turns the pulling cable upward toward the winch places stress on the cable at the point where the cable turns upward. This concentrated stress point is frequently where the cable breaks because of the large amount of force that is applied to the cable.

The use of a bursting head required that only two pits be dug, one at each end of the pipe to be replaced. The first pit allowed the bursting head to be introduced into the old pipe. The second pit was for placement of the hydraulic pulling apparatus. This eliminated the need to dig up the entire pipe, but still required the two pits to be dug. Further, the prior art bursting heads were attached to the pulling cable by a pin and clevis type arrangement. The clevis was attached to the pulling cable by a swaged connection. The bursting head had a bar extending from its nose through which a pin extended or to which a pin was welded. The clevis engaged the pin and a cotter key or other similar arrangement kept the clevis from disengaging the pin.

One problem with this prior art bursting head arrangement was that the bar and pin extended out from the nose of the bursting head by several inches. Typically, the hydraulic pulling arrangement used a base plate against the side wall of the pulling pit out of which the bursting head will be pulled. This base plate had a slot through which the cable passed. The pulling mechanism typically used a clamping mechanism to act like a check valve to clamp against the cable during the cyclic pulls, but to release it during retractions to take another “bite” of cable for another pull. In some of these prior art arrangements, a pulley was used so that the cable emerged horizontally from the wall of the pulling pit and was turned vertically upward by the pulley toward the pulling mechanism. In either case, the clevis and pin arrangement would be pulled through the slot in the footing plate and would immediately encounter either the clamping mechanism or the pulley and not be able to be pulled further into the pulling pit. Because the pin and clevis arrangement extended quite a few inches out from the tip of the bursting head, this left most if not all of the bursting head encased in earth behind the footing plate. This meant that the bursting head had to be dug out of the earth which takes more time and physical exertion.

This problem was solved by a bursting head that the inventor of the invention claimed in this patent application has been using publicly for more than a year. This prior art bursting head is shown in FIG. 5 of this application. However, the bursting head of FIG. 5 has a 12 degree slope on its bursting cone, and this causes it to be hard to pull and requires a strong hydraulic pulling unit.

Another problem with the prior art hydraulic pulling arrangements is that they were not very powerful and they were physically large. It takes a great deal of force to pull a bursting head through an old pipe to fracture it—typically 60,000 pounds. The large size was caused by using long, large diameter pistons to obtain enough cross sectional area to provide sufficient pulling force. Long cylinders were used so that for each stroke, more cable could be pulled out of the hole which was important to completing the job quickly. The prior art systems were not automated, so pulling more cable with one stroke led to fewer manually controlled repetitions and a shorter time to completion. The problem with these large hydraulic pulling rigs with long hydraulic cylinders was that they required large pulling pits to be dug. This was labor intensive, slow and expensive.

A patent application entitled UNDERGROUND PIPE BURSTING HEAD AND SYSTEMS TO PULL IT THROUGH PIPE by Rod Herrick and Rick Leyva, filed in the U.S. on Dec. 1, 1999, Ser. No. 09/452,914 also discloses a bursting head and a hydraulic pulling arrangement for same. The bursting head is similar in design to the invention described herein but there are several significant differences that make it harder to pull, harder to attach a pulling cable and harder to attach a replacement pipe.

Thus, a need has arisen for a strong, small hydraulic pulling arrangement and an improved bursting head design.

### SUMMARY OF THE INVENTION

There is disclosed herein an improved bursting head which has the connection between the cable made inside the bursting head by a threaded nose piece and with a more shallow slope for easier pulling, with an improved cable clamping mechanism, and with an improved attachment mechanism to couple a replacement pipe to the bursting head.

More specifically, the bursting head is comprised of:

a truncated complex shaped bursting cone having a left hand threaded opening at the tip and having a shape with at least two different slopes, the slope from said opening back toward the rear of said bursting cone being substantially more shallow than prior art bursting heads;

a cutting fin attached to or formed integrally with said cone shaped body;

a leader having an opening therethrough big enough to allow a pulling cable to pass therethrough and having a left hand threaded projecting portion which engages said left handed threaded opening of said bursting cone, and having a sloped inside camming surface;

cable clamping means which engage said camming surface of said leader, for allowing a cable to be inserted into said bursting cone through said opening in said leader and for gripping said cable at a point inside said projecting portion of said leader in such a manner that when said cable is pulled, said grip becomes tighter; and

replacement pipe gripping means permanently or partially permanently or removably attached to said bursting cone, for allowing a replacement pipe to be slit into said replacement pipe gripping means and for allowing the pipe to be gripped with a grip which increases as said replacement pipe is pulled in a direction to tend to disengage it from said replacement pipe gripping means.

### BRIEF DESCRIPTION OF THE DRAWINGS

FIG. 1 is a drawing of a typical situation in which the invention finds utility.

FIG. 2 is a comparison between an improved prior art bursting head in the foreground and another prior art bursting head in the background.

FIG. 3 is an exploded view of a prior art bursting head showing the threaded nose piece and the swaged cable end before engagement with the bursting head.

FIG. 4 is a view of the prior art bursting head arrangement showing how the cable was attached to the bursting head with a pin and clevis arrangement.

FIG. 5 is a drawing showing a prior art bursting head fully assembled and about to be pulled into a pipe to be burst, and illustrating another embodiment for the bursting head.

FIG. 6 is a drawing of an improved prior art hydraulic pulling arrangement in place in a pulling pit.

FIG. 7 is an end perspective view of hydraulic pulling arrangement.

FIG. 8 is a closeup perspective view of a prior art hydraulic pulling arrangement.

FIG. 9 is a drawing of the automatic cycling embodiment for a prior art hydraulic pulling unit.

FIG. 10 is a hydraulic and electrical schematic of a controller for an automatic prior art hydraulic pulling embodiment.

FIG. 11 is a flow chart of a typical program that can be used to control the microcontroller.

FIG. 12 is a view of the underside of the block 130 showing the cable clamp 150 is a position where a pulling cable may be placed between the clamping jaw dies.

FIG. 13 is a bottom view of the hydraulic cylinder block showing the second cable clamp 170 in the fully closed position where it would be while grasping a cable.

FIG. 14 is a perspective view of an alternative embodiment of a hydraulic pulling arrangement.

FIG. 15 is a detailed view of the releasable clamp which is used in the tilted embodiment of FIG. 14 but which can also be used in any other embodiment as well.

FIG. 16 is a top closeup view of the improved pulling device showing a sensor setup.

FIG. 17 is a cross-sectional view of the improved bursting head according to the teachings of the invention.

FIG. 18 is an exploded view of the preferred embodiment of an improved bursting head according to the invention.

### DETAILED DESCRIPTION OF THE PREFERRED AND ALTERNATIVE EMBODIMENTS

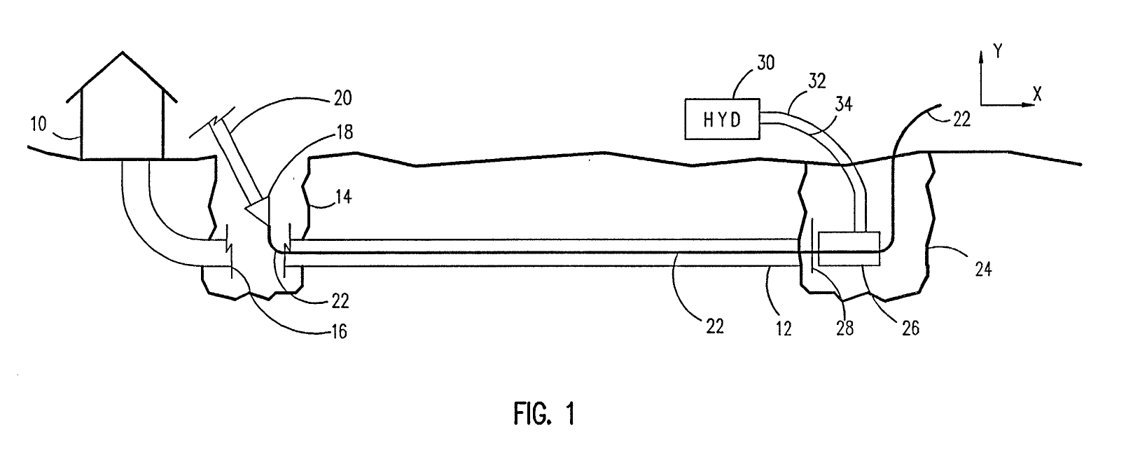

Referring to FIG. 1, there is shown a diagram of a typical situation in which the invention finds utility. Building 10 has a water supply line 12 that has become too small for the desired service. In order to replace the pipe with a larger pipe, a first pit 14 is dug down to the pipe, and the pipe is broken at 16 intentionally in order to introduce bursting head 18 into the old pipe 12. The bursting head 18 has a tip which has a smaller diameter than the inside diameter of the pipe to be fractured or cut (the bursting head can either fracture tile or cement pipes or cut PVC pipes with its cutting vane which is not shown). The bursting head has a conical shape with the largest diameter larger than the inside diameter of the pipe 12. The bursting head has welded (by plastic or PVC cement or by an actual metal weld in the case where the new pipe is metal) to it the new pipe 20. The tip of the bursting head is introduced into the end of the old pipe after engaging a pulling cable 22 with the bursting head.

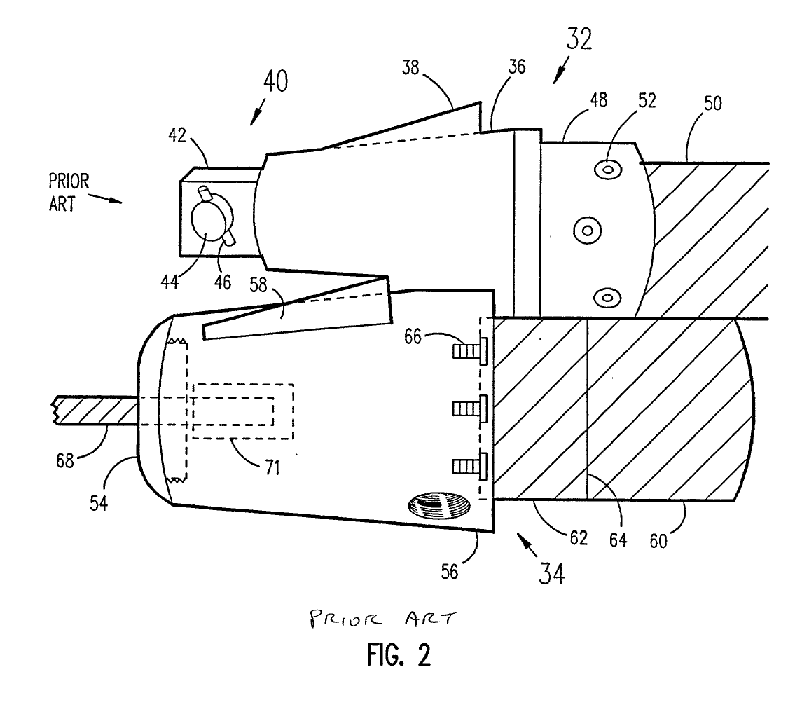

The pulling cable is run through the old pipe to a pulling pit 24 where it is engaged by a hydraulic pulling apparatus 26. The pulling apparatus has one or more hydraulic cylinders that pull on the pulling cable 22 by repetitive strokes which move a block and clamp arrangement that grabs the cable when the piston of the hydraulic cylinder is moving in the pulling direction along the positive x axis. A hydraulic power pack 30 supplies hydraulic power via hydraulic lines 32 and 34 to the pulling apparatus. The pulling cable passes through a slot in a footing plate 28 which is placed against the wall of the pulling pit 24 from which the old pipe emerges. The footer plate serves to provide a stable surface against which the hydraulic pulling apparatus can push while pulling the cable. FIG. 2 is a diagram which compares the prior art type bursting head with the improved bursting head, although either type may be used with the improved pulling arrangement. One prior art bursting head is shown at 32. The improved bursting head is shown at 34.

In the prior art bursting head 32, a conical shaped bursting head with a sharpened cutting fin 38 is used by burst the old pipe. This is done by attaching a pulling cable to the pin and bar arrangement shown generally at 40. A bar 42 is attached to the bursting head inside the cone portion 36 by any suitable means such as a bolt pattern. The bar extends past the tip of the cone 36, typically by 4-6 inches. The bar has a pin 44 attached thereto either by passing the pin through a hole in the bar to form an interference fit or press fit engagement or by welding the pin to the bar. The pin can extend out perpendicularly from both surfaces of the bar or just one surface. The pin has a cotter key hole through a second smaller pin can be placed to keep the pulling cable engaged with the pin 44.

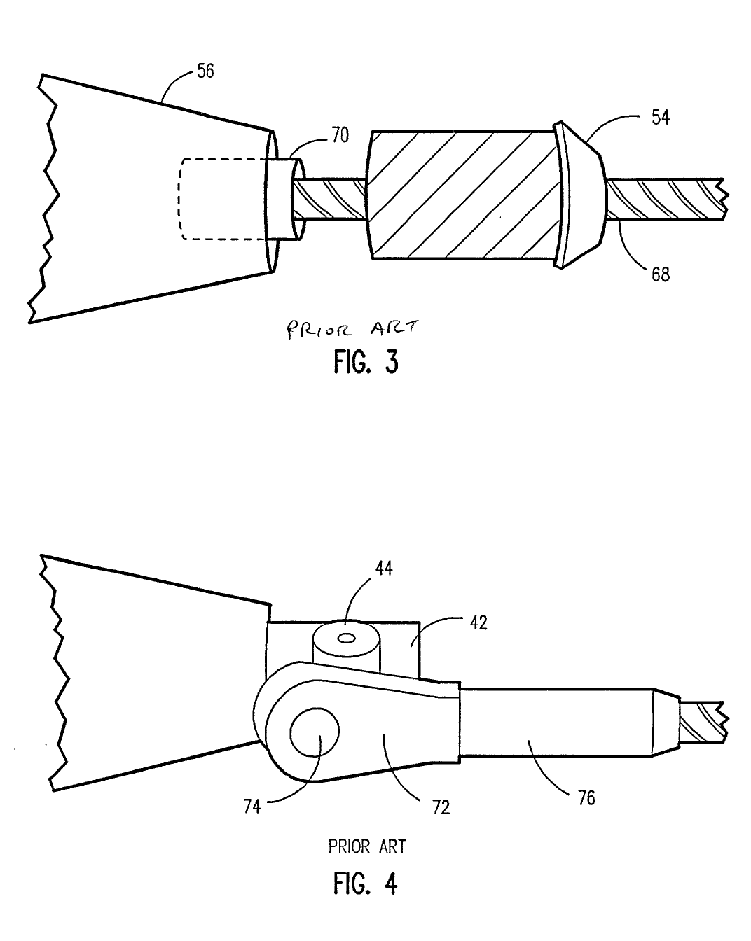

The pulling cable has a clevis type coupler shown at 72 in FIG. 4 swaged thereon with a hole 74 big enough to engage the pin 44. The clevis is engaged with the pin 44, and second pin 46 keeps it from slipping off during the pulling operation.

The problem with the prior art bursting head is that the bar and pin extend 4-6 inches past the tip of the cone 36. Then the clevis takes up even more space and the swaged connection, 76 in FIG. 4, between the pulling cable and the clevis takes up even more space. This is because the swaged connection between the clevis and the cable causes the cable portion within the swaged connector to not have its native diameter throughout the length of the swaged connection. Therefore, when the swaged connection on the pulling cable reaches the clamp or pulley on the hydraulic pulling mechanism, it binds and cannot penetrate further into the pulling mechanism. This means that the pulling is over, and wherever the bursting head is along the path of the old pipe, that is where it will stay until dug out of the ground by removing the footing plate 28 in FIG. 1 and digging into the dirt wall.

The prior art bursting head included a metal sleeve 48 which is bolted or welded to the back end of the bursting head. This sleeve fits over and attaches to a new pipe 50 that the bursting head pulls along behind it which replaces the old pipe being burst. The new pipe is attached to the sleeve 48 by threaded fasteners of which 52 is typical.

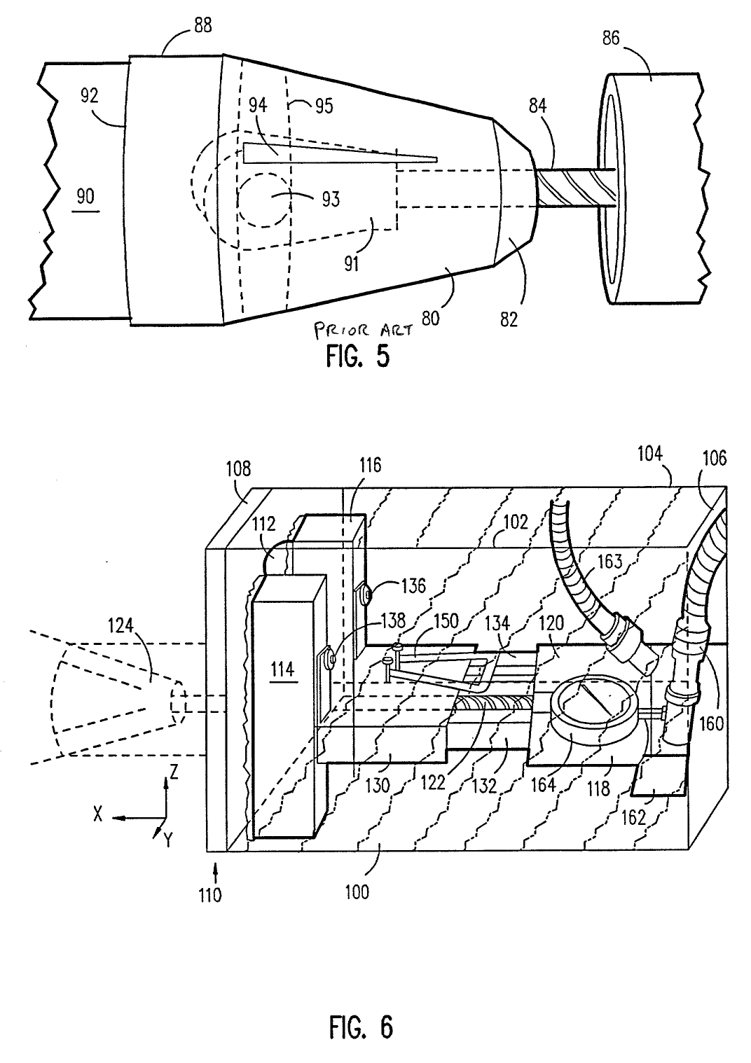

In contrast, the improved bursting head 34 is much more compact and, by virtue of the manner in which the cable is attached, can be pulled further out of the ground. The pulling cable passes through a cap 54 and is attached to the improved bursting head 34 inside cone portion 56. In the claims, the term “truncated cone” means the shape of body portion 56 shown in the lower burst head of FIG. 2 with a cylindrical portion merging with a cone portion with the tip cut off where a threaded or unthreaded end cap 54 joins the cone to form a tip through which the pulling cable runs. However, it is not necessary that there be a cylindrical portion to the cone, and it may be conical all the way to the end which joins with cuff 62. The phrase “opening at the tip” in the claims means that the cone shaped body is hollow or at least partially hollow at the end having the smallest circumference which is large enough to receive an end plug such as threaded end cap 54 in FIG. 2 or end cap 82 in FIG. 5.

The cone portion 56 has a sharpened cutting fin 58 which is welded to the cone shaped body or which is machined integrally with the cone shaped body. The fin concentrates stress on the inside of brittle concrete and tile pipes and causes them to fracture and is usually sharp enough to cut plastic pipes. The new pipe 60 is butt welded by suitable cement at butt joint 64 to a plastic cup shaped trailer or “cuff” 62. The cup shaped trailer is bolted to the inside of the cone portion 56 by a pattern of bolts of which bolt 66 is typical.

The preferred manner in which the pulling cable is anchored to the bursting head in the preferred embodiment is illustrated in FIG. 3. Cap 54 is threaded into the nose of the cone portion 56, and has a passage therethrough through which the cable 68 passes. The end of the cable has a terminator 71 swaged (crushed onto) on the end thereof. The terminator has an outside diameter which is larger than the passage through the cap 54. When pull is exerted on the cable, the swaged end tries to pass through the passage in the end cap, but this passage is too small. The pulling force is thereby transmitted to the bursting head body through the threads of the end cap 54. This is the meaning of the phrase “means for attaching a pulling cable to said cone shaped body” in the preferred embodiment of the bursting head. Another meaning is the anchoring arrangement of FIG. 5 where the pulling cable has a clevis 91 swaged onto the end which engages a pin 95. The pin is typically anchored in two holes in opposite surfaces of said bursting head. The holes or (one of them) may be threaded to securely anchor the pin when it is passed through the clevis and threaded into the holes. One embodiment would utilized one threaded hole and a pin which is threaded at one end only with the rest of the pin being smooth and engaged with a hole opposite the threaded hole.

The class of anchoring arrangements covered by the phrase “means for attaching a pulling cable to said cone shaped body” in the claims is intended to cover the genus of any mechanical arrangements for attaching the cable to the bursting head to transmit force thereto where the mechanism for attaching the cable to the bursting head is completely or mostly contained within the interior of the bursting head as opposed to somewhere out in front of the tip of the bursting head or its end cap such that when the pulling cable is pulled through the base plate slot and into the mechanism of the pulling arrangement, the first thing other than cable which would encounter the pulling mechanism would be the end cap and not the attachment mechanism.

To use the improved bursting head, the end of the pulling cable 68 which does not have the terminator thereon is threaded through the cap 54 and passed through the pipe to be replaced. The cable is then engaged with the clamping mechanism on the pulling mechanism (not shown), and the cap 54 is threaded into the nose of the cone 56. The new pipe that is to be pulled into the place of the old pipe is then welded to the cup shaped trailer 62. The nose of the cone is then introduced into the pipe to be burst, and the pulling cable is repeatedly pulled until the bursting head has passed through the entire pipe to be replaced.

More precisely, the process is as follows:

threading the end of a pulling cable that does not have a clevis or terminator swaged or otherwise fastened thereto through a hole in an end cap of said improved bursting head which is large enough for the cable to pass through, but not large enough to allow the terminator or clevis to pass through;

anchoring said pulling cable to said bursting head by engaging said clevis with a pin that passes through or partially through said bursting head or by threading said end cap into a threaded hole in the tip of said bursting head thereby engaging said bursting head in such a manner that when said pulling cable is pulled, the pulling force is coupled to said bursting head;

attaching a new pipe to be pulled into place behind said bursting head to the back end of said bursting head;

threading the end of said pulling cable not engaged with said bursting head through the pipe to be replaced by digging a first pit down to the pipe and breaking the pipe such that said cable can be introduced thereto;

digging a pulling pit at a location along said pipe marking the end of the section to be replaced and breaking the pipe and fishing said pulling cable out through said breach;

placing an anchor plate having a slot therein against the wall of said pulling pit through which the pipe to be replaced emerges;

attaching a hydraulic mechanism to said anchor plate and engaging said pulling cable with said pulling mechanism;

engaging said pulling cable with said pulling mechanism;

repetitively pulling on said cable with said pulling mechanism to draw said bursting head and the attached new pipe through the pipe to be replaced thereby bursting or cutting the old pipe and replacing it with new pipe; and

removing the pulling mechanism and anchor plate from said pulling pit and digging the portion of said bursting head still in the ground out, and disconnecting the new pipe from said bursting head.

Referring to FIG. 5, there is shown an assembled improved bursting head about to be engaged with a pipe to be burst, and also illustrates another embodiment for the bursting head. The bursting head 80 has the threaded nose piece 80 fully threaded into the head such that pulling cable 84 can pull the bursting head into the pipe 86 to be replaced or resized. A pipe collar 88 with a new pipe 90 butt welded thereto at joint 92 is pulled into the hole behind the bursting head. The sharp blade 94 either fractures or slices open the old pipe 86 as the bursting head is passed through the pipe. The bursting head embodiment of FIG. 5 differs from the embodiment shown in FIG. 2 in the way the cable attached to the head. In FIG. 5, the cable has a clevis 91 swaged onto the end thereof. The clevis has a hole 93 therein which engages a pin 95 (all shown in phantom). Although the clevis is shown as slightly larger than the nose aperture of the bursting head, that is because the author cannot draw and not because that is the way it is supposed to be built. The clevis is actually supposed to be small enough to be slid into the hole into which the nose piece 82 is engaged. The nose piece 82 can either be threaded into the nose of the bursting head or just slide into it since there is no pulling force being exerted on the nose piece 82. The pin 95 in engaged with the hole in the clevis after the cable is threaded through the nose piece 82 and the clevis is introduced into the bursting head. The pin is slid through the bursting head through two holes in the outer surface of the bursting head. The pin is typically just long enough to lie flush with the surface of the bursting head surfaces but must be long enough to engage the holes on both sides of the bursting head so as to transmit the pulling force from the cable to the bursting head.

Referring to FIG. 6, there is shown an improved hydraulic pulling arrangement positioned in a pulling pit in the position normally used to pull the bursting head through the pipe. The bottom surface of the pulling pit is represented by surface 100 and the left and right sides are represented by edges 102 and 104. The back edge of the pulling pit is represented by edge 106 and the front edge of the pulling pit is hidden behind the edge 108 of a footing or anchor plate 110. The footing plate 110 is placed against the edge of the pulling pit out of which emerges the old pipe to be replaced. The function of the footing plate is to provide a solid base against which one or more hydraulic cylinders 118 and 120 can push without sinking into the earth. Preferably, two hydraulic cylinders are used so that the pulling cable may be attached to the cylinders between them for a symmetrical pull. However, in some embodiments, a single larger cylinder could be used with optional parallel guide rails to guide its pull and retract strokes, and a cable clamp could be attached to the hydraulic cylinder casing or a metal block coupled to the casing along the centerline of the piston.

The footing plate has a longitudinal slot 112 therein which is usually centered and which serves as an aperture through which the pulling cable extends into the old pipe to engage the bursting head shown at 124. The slot 112 is usually wide enough for the tip of the bursting head to pass through, but is usually not wide enough for the whole bursting head to pass through although that too would be permissible.

The footing plate typically has two spacer bars 114 and 116 welded to the footing plate on opposite sides of the slot 112. The purpose of the spacer bars is to act as anchor points for a base block 130 of the hydraulic cylinder pistons 132 and 134 and to move the anchor points far enough away from the footing plate 110 that at least the nose of the bursting head can be pulled out of the earth far enough that not much digging is necessary to get the rest of the bursting head out after the job is done. The base block 130 is shown bolted to the spacer blocks at 136 and 138.

The hydraulic cylinder pistons 132 and 134 are anchored in the base block 130. The base block also supports a one way cable clamp shown at 150. The part of the cable clamp shown at 150 is just the part that keeps the dies (not shown) on the under surface of the base block 130 from falling out of their grooves when not engaged with a cable. The function of the cable clamp 150 is to grab the cable in a non-slip fashion and keep tension on it after the pulling stroke in the negative x direction by the hydraulic cylinders. This keeps the cable from moving in the positive x direction when the hydraulic cylinders (which have their own cable clamp) have relaxed their grip and are retracting so as to move the cylinder portions in the positive x direction toward the base block 130. In other words, the cable clamp 150 acts as a “check valve” to keep the cable from back sliding when the hydraulic cylinders are retracting to a position to make another pull stroke.

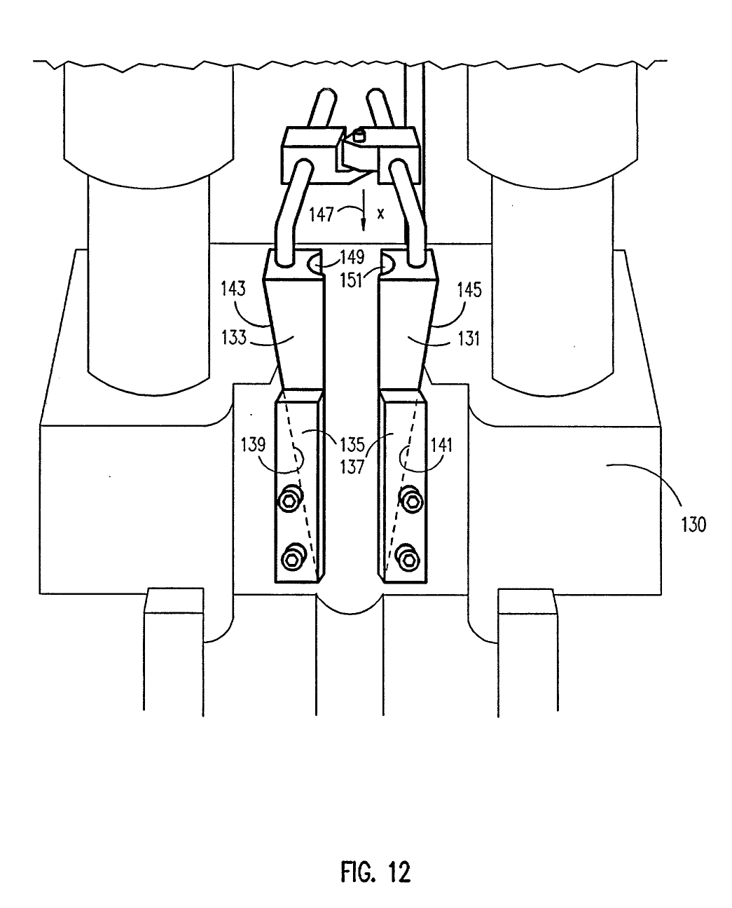

The cable clamp 150 is best seen in FIG. 12 which is a view of the underside of the block 130 showing the cable clamp 150 is a position where a pulling cable may be placed between the clamping jaw dies. The cable clamp is comprised of two hard steel dies 131 and 133 that slide up and down in slots formed in the undersurface of the base block 130 by bolt on plates 135 and 137. The slots are machined in the block 130 to have sloped surfaces 139 and 141 (shown in phantom beneath the bolt on plates). The dies each have matching sloped edges 143 and 145 that ride on the sloped sides 139 and 141 to provide a camming action to force the dies 133 and 135 closer together when a cable is placed along the x axis 147 and pulled in the positive x direction. The dies have semicircular serrated grooves 149 and 151 formed therein to grasp the pulling cable. The serrated edges of the dies act as teeth to dig into the cable when a pull in the positive x direction is being asserted on the cable and the dies are forced by the camming action to move closer together. That is, when a pull is being asserted in the positive x direction, the forces exerted on the dies by the engagement of the cable are such as to force the dies closer together thereby digging the teeth into the cable further thereby grasping the cable more firmly and preventing it from backsliding in the positive x direction back into the hole. The cable clamp has the same configuration as it had in the prior art hydraulic pulling devices.

There are two cable clamps like clamp 150. The other is on the hydraulic cylinders and is not shown in FIG. 6. The structure of the other cable clamp is the same as cable clamp 150, but the groove slope orientation is reversed so that the dies grab the cable harder when a pull is being put on the cable in the increasing negative x direction.

The hydraulic cylinders are fed hydraulic oil under pressure through supply line 160 when a pulling stroke is to be carried out. When line 160 is pressurized, oil under pressure enters a “pull” passageway of manifold 162 where it is piped to the “pull” ports of cylinders 118 and 120. The oil enters the pull ports and the space between the top of the piston (not shown) inside the cylinders 118 and 120 and the top of the cylinders. The highly pressurized oil drives the top of the pistons down in the cylinders in the positive x direction which causes the top of the hydraulic cylinders to move in the increasingly negative x direction during a pulling stroke. Oil in the cylinders 118 and 120 under the piston head is pushed out a return port in the cylinders and is piped to a “return/retract” passageway in manifold 162 where it is coupled to a return line 163 and returned to the hydraulic supply unit. Pressure gauge 164 allows pressure in the pull line 160 to be monitored for troubleshooting purposes and generally monitoring.

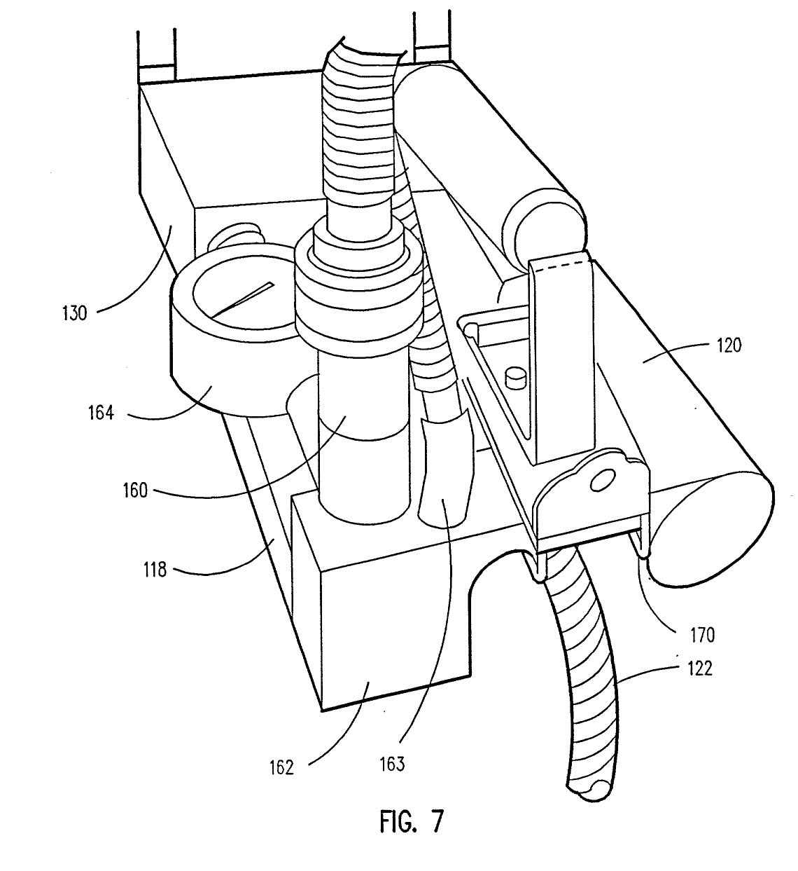

The top of the cylinders 118 and 120 are anchored in the manifold block 162 which also serves as a mechanical support for the cable clamp (not shown in FIG. 6, but shown at 170 in FIG. 7) that grabs the cable during pull strokes.

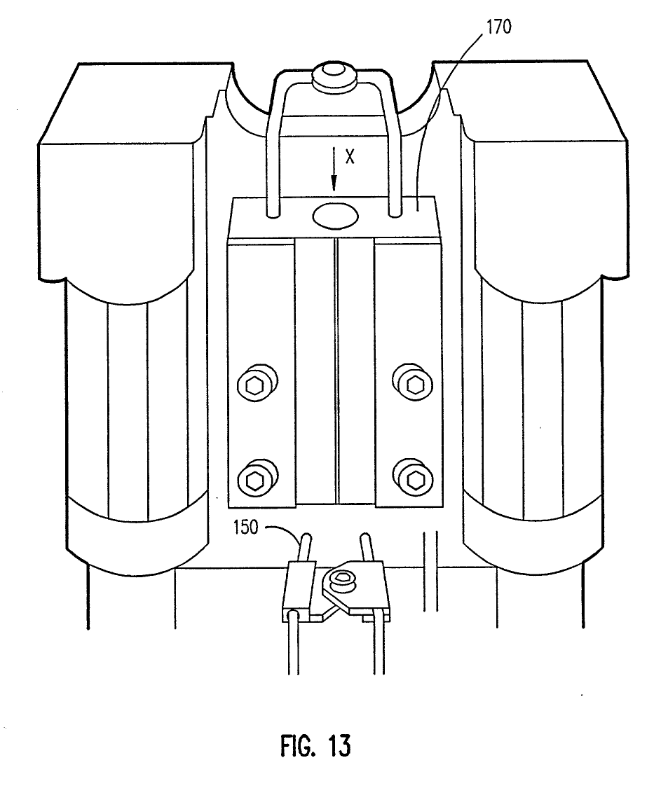

FIG. 13 is a bottom view of the hydraulic cylinder block showing the second cable clamp 170 in the fully closed position where it would be while grasping a cable. The configuration is identical to the configuration of cable clamp 150 such that when the hydraulic cylinders move the cable clamp in the negative x direction, the cable appears to be moving in the positive x direction so cable claim 170 grabs the cable by the camming action so as to pull on the cable during the pulling stroke.

The hydraulic cylinders 118 and 120 used in the embodiment shown in FIG. 6 are a major improvement over the prior art. First, they are very short and compact, and it is this property which makes the overall pulling device shorter thereby enabling the pulling pit to be made smaller and requiring less digging. However, the use of two cylinders and the cross sectional area of the piston heads allows enough force to be exerted on the cable (up to 60,000 pounds frequently) to burst any pipe. The methods of swaging or otherwise attaching the cable end or clevis to the end of the pulling cable is the same as it was in the prior art since the forces have not changed from what they were in the prior art.

FIG. 7 is an end perspective view of the hydraulic pulling apparatus showing the position of the cable clamp 170 mounted on the manifold block 162. The cable clamp 170 works the same way as cable clamp 150 in FIG. 6, but grabs the cable when pull in the increasingly negative x direction occurs.

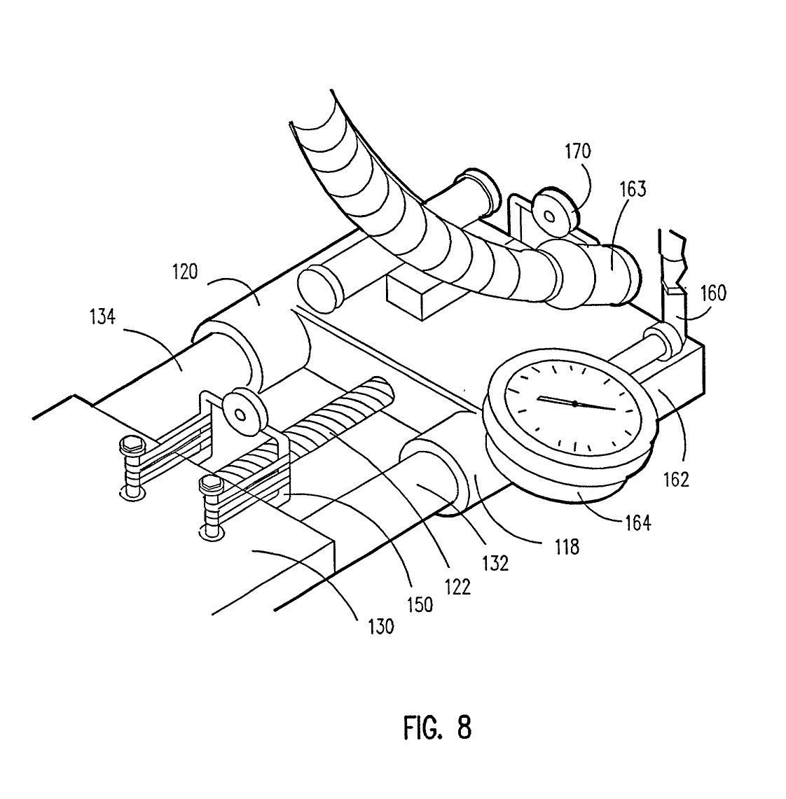

FIG. 8 is a closeup perspective view of the hydraulic pulling arrangement showing it in more detail.

Any mechanical arrangement that meets the following criteria falls within the genus for the hydraulic pulling arrangement.

First, the arrangement should allow the use of one or more, preferably two, relatively short hydraulic cylinders (compared to the prior art cylinders), and where two or more cylinders are used, they must have their “pull” and “retract” hydraulic ports hydraulically coupled together so that all cylinders expand and contract in unison. The number of cylinders used is not critical so long as they can provide enough pulling force. Likewise, the manner in which the hydraulic ports are coupled together is not critical, so long as the cylinders pull in unison and retract in unison. Shortness (shorter than the prior art) and adequate strength are the key.

Second, the arrangement must have at least one cable clamp arranged be such that when “pull” port(s) are pressurized and the cylinder expands, the cable clamping arrangement grasps the cable and pulls it in a direction so as to pull the bursting head through the pipe to be replaced. The cable clamp must also be arranged so as to release the cable when the retract port(s) are pressurized. The use of two cable clamps, is not necessary, but is preferred, one acting to prevent back sliding of the cable during the retract stroke and one to pull the cable during the pull stroke.

One species that is within the genus of the pulling arrangement and which is the preferred manner of operating the system using an automatic cycling hydraulic pressure pack to automatically cycle between pull and retract strokes. Specifically, the hydraulic pulling arrangement can be operated manually to implement a pull stroke by controlling the hydraulic pressure source manually to pressurize pull line 160 while allowing fluid in return line 163 to flow back into the reservoir. A retract stroke is then implemented manually by controlling the hydraulic pressure pack to pressurize the return/retract line 163 while allowing fluid in line 160 to flow freely back into the reservoir. The preferred embodiment uses a hydraulic pressure pack coupled to a set of solenoid controlled multiplexer valves with the solenoids controlled by a programmable controller. The controller is programmed to receive a start command and then to enter an automatic cycling mode to control the solenoid controlled multiplexer valves to alternately pressurize the pull line 160 and then the retract line 163 and to keep cycling the pressurization of these lines until a stop command is received. This causes repeated pull and retract strokes without further manual intervention until the stop command is given.

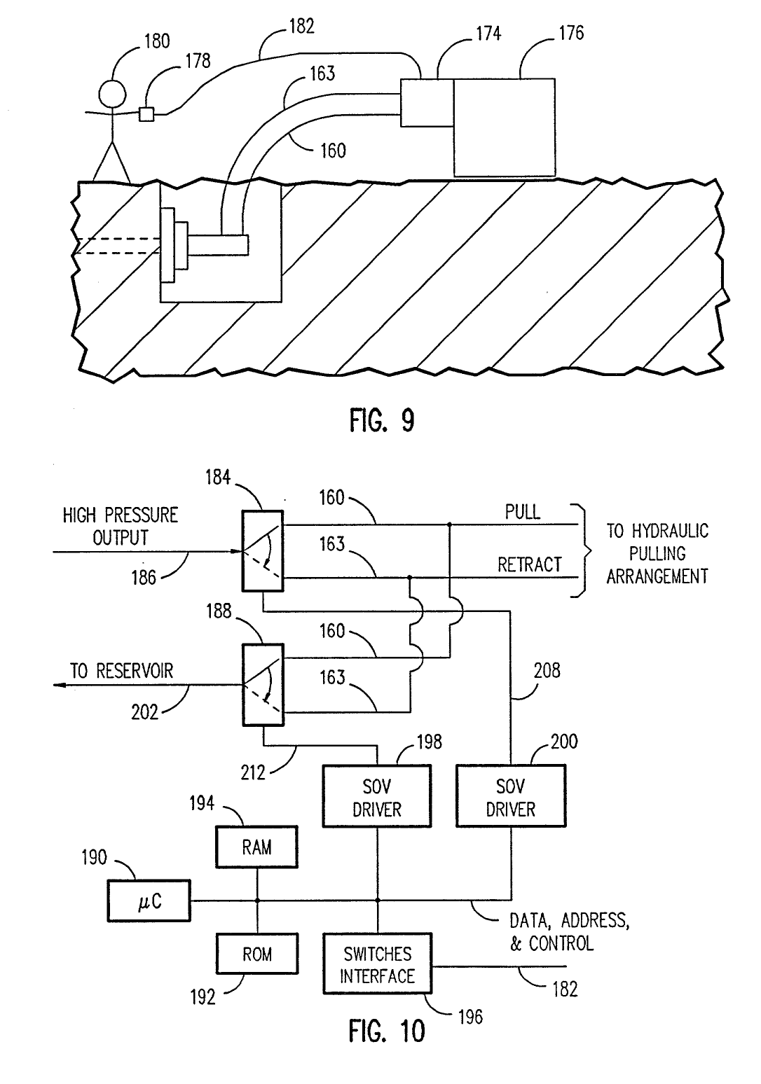

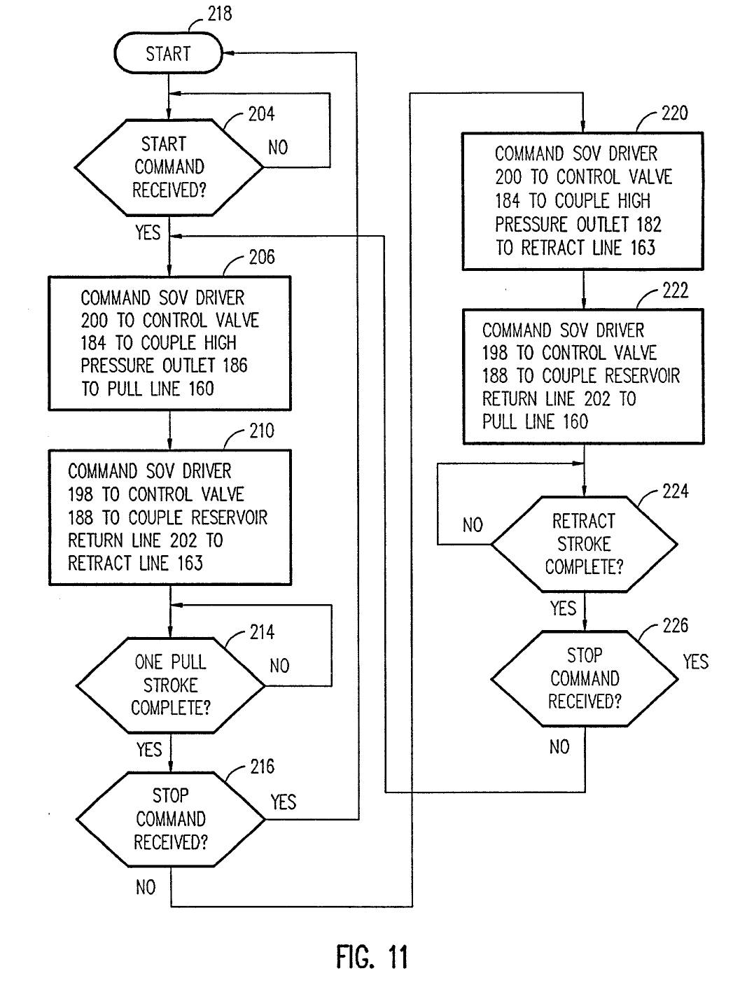

FIG. 9 is somewhat inartistic attempt to show how an operator 180 controls a hydraulic power pack 176, which is a conventional hydraulic pump and reservoir powered by a gasoline engine, via a controller system 174 and a handheld switch box 178. The hydraulic pump can also be driven by an electric motor. The details of the solenoid operated valves, microcontroller and peripheral circuitry in controller system 174 are shown in FIG. 10, and the details of the computer program that controls the microcontroller are given in FIG. 11. The operator sends a start command via the switch box 178 and control wires 182 to cause the controller 174 to start automatically cycling pressure between the pull line 160 and the retract line 163. In alternative embodiments, this could also be a wireless system where instead of a switch box 178 there would be an RF transmitter or infrared transmitter substituted to transmit the start and stop commands by RF or infrared to the controller 174 which would be equipped with a suitable receiver.

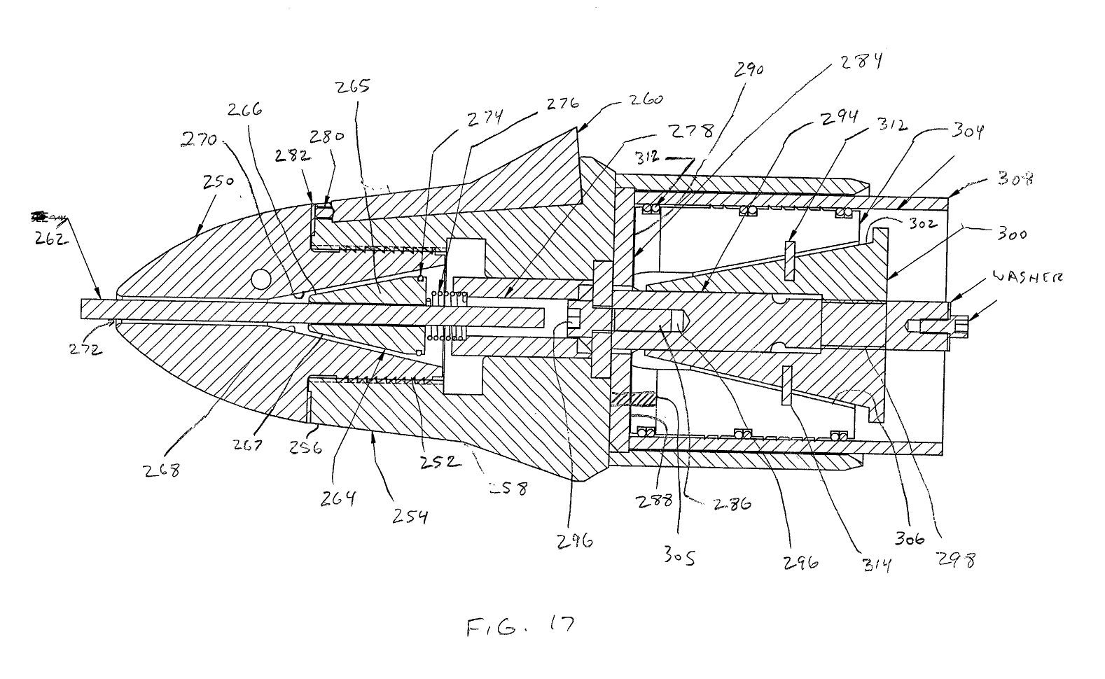

FIG. 10 is a hydraulic and electrical diagram of the controller system 174 in FIG. 9. The function of the controller is to automatically control a first solenoid operated valve multiplexer 184 and a second solenoid operated valve multiplexer 188 appropriately to carry out repetitive pull and retract strokes. The structure and program of the controller is not critical so long as it is capable of carrying out this function. The controller uses a microcontroller under the control of a program stored in ROM 192 to do this and uses RAM for storing any necessary data temporarily. The microcontroller interfaces with the outside world via a switches interface 196 and solenoid operated valve drivers 198 and 200 and a end of stroke sensor or sensors. The end of stroke sensor(s) can be anything from microswitches that physically sense the position of the hydraulic cylinder(s) relative to the block 130 to proximity sensors like sensors 234 and 236 in FIG. 16 to pressure sensors coupled to the hydraulic lines that sense the rise in pressure therein when the pistons bottom out at either extreme. In wireless embodiments, the switch interface will be an RF or infrared receiver. In some embodiments, the switches in the handheld controller 178 may be coupled directly to the microcontroller, although this would be unusual design.

FIG. 11 is a flowchart of a typical program that can be used to control the controller to carry out its function stated above. The program controls the microcontroller to wait for a start command in test 204. When a start command is received, and not before, step 206 is performed. This step commands the SOV driver 200 to control solenoid operated valve 184 via a signal sent on line 208 in FIG. 10 to change to a state where the high pressure output line 186 is coupled to the pull line 160. Next step 210 is performed where the microcontroller commands the SOV driver 198 to send a signal to solenoid operated valve 188 via line 212 to cause it to switch to a state where the reservoir return line 202 is coupled to the retract line 163. This causes the pull stroke to start.

Next test 214 is performed to determine if one pull stroke is completed. If not, the valves 184 and 188 remain in their then existing state until one pull stroke is completed. The completion of one pull stroke can be determined either by a timer which times out at a time which is known to be long enough for one pull stroke to always have been completed even on the toughest pulls or it can be by receiving input from electrical or optical sensor switches or other sensor devices which sense either the position of the hydraulic cylinder relative to the base block 130 or sense the end of the stroke by sensing a rise in pressure on the pull line 160 which occurs when the pistons bottom out and no more extension of the hydraulic cylinder(s) is occurring. How the end of the stroke is sensed is not critical.

Next, test 216 determines if a stop command has been received from the hand controller 178 or transmitter. If it has, processing vectors back to the start label at 218. If the stop command has not been received, processing vectors to step 220. Step 220 represents the first step in starting the retract stroke. In step 220, the microcontroller commands the solenoid operated valve driver 200 to send a signal via line 208 to control valve 184 to couple the high pressure output line 182 to the retract line 163. Then step 222 is performed wherein the controller commands SOV driver 198 to send a signal via line 212 to control valve 188 to couple reservoir return line 202 to to pull line 160. These two steps cause pressurized oil to be applied to the retract line which is coupled to the hydraulic port underneath the piston head in the hydraulic cylinder to cause it to push the piston back up to the top of the cylinder. Simultaneously, oil above the piston is pushed into the pull line 160 and is coupled through valve 188 to the reservoir.

Next step 224 is performed to determine if the retract stroke is complete. This can be sensed by any of the methods and apparatus discussed above in connection with the discussion of step 214. Finally, step 226 is performed to determine if the stop command has been received. If it has, processing vectors back to step 204 to wait for the next start command. If not, processing vectors to step 206 to start the next pull stroke.

In alternative embodiments, steps 224 and 226 can be reversed in order as can steps 214 and 216.

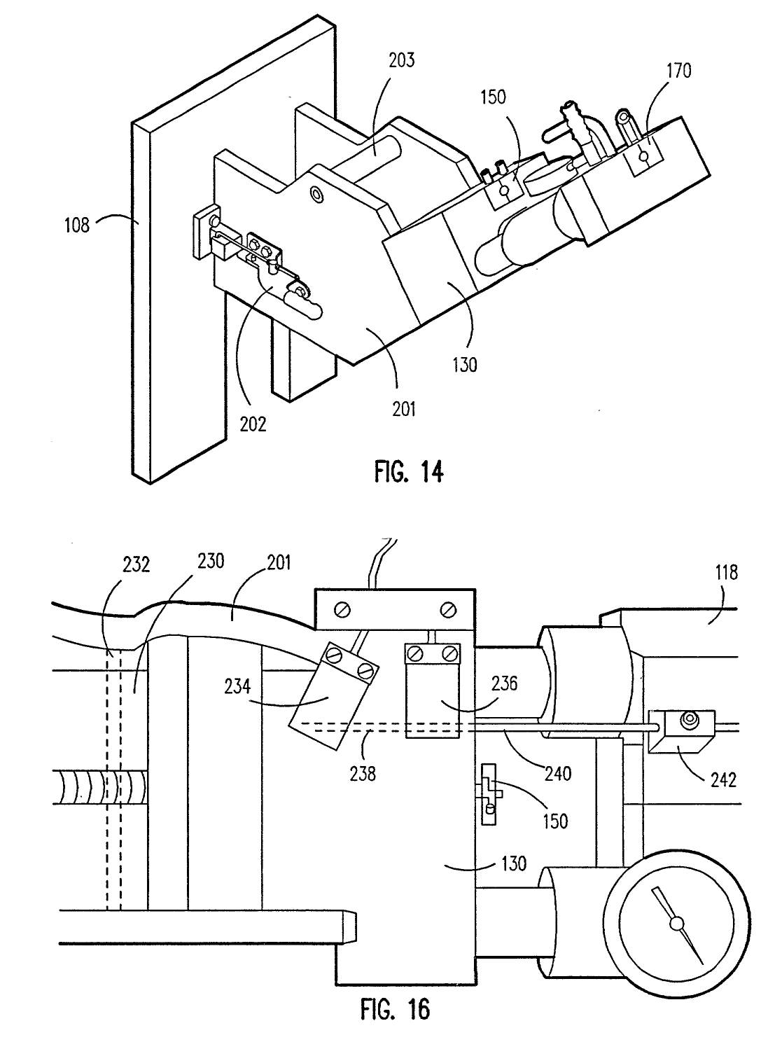

Referring to FIG. 14, there is shown a perspective view of an alternative embodiment of a hydraulic pulling arrangement. In this embodiment, the hydraulic cylinders are tilted up at approximately a 45 degree angle from the horizontal to make it easier to access the underside cable clamps 150 and 170 to engage the cable. A footer plate 108 has attached thereto a tilted block 201 which is attached to the footer plate by at least one and preferably two releasable clamps of which only clamp 202 is visible. The tilted block has first and second spacer plates which held in parallel relationship to each other by at least one support of which support 203 is visible. The parallel plates which serve as the anchor points for an axle 232 around which a pulley 230 revolves.

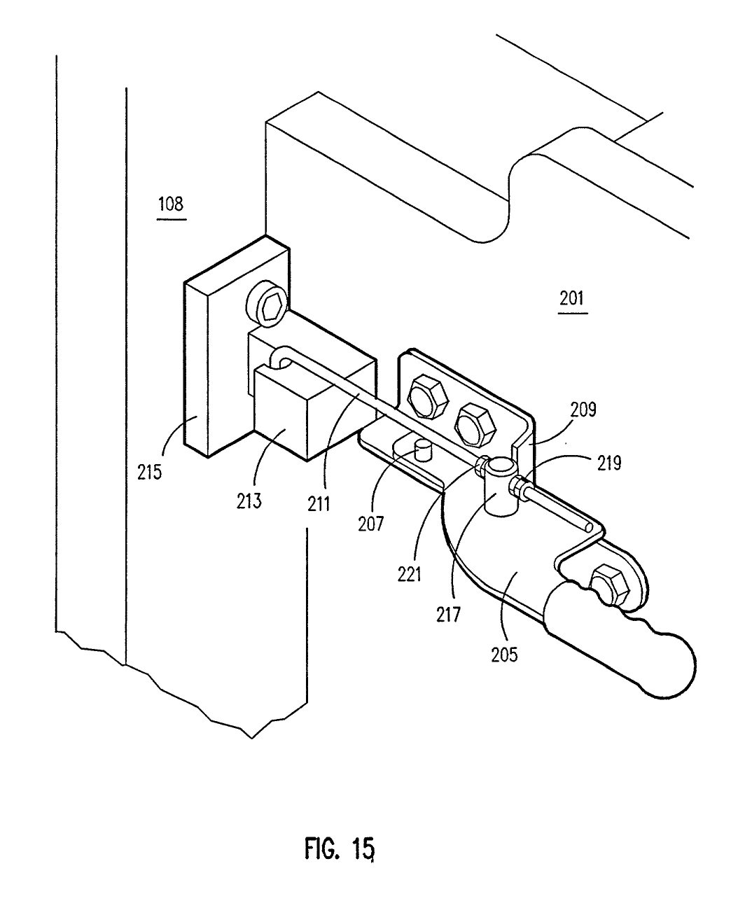

A more detailed view of the releasable clamp is shown in FIG. 15. The releasable clamp can also be used in any other embodiment as well. The clamp is comprised of a handle which pivots around pin 206 which is anchored in bracket 208 which is bolted to the side of block 201. The handle pulls a hook 210 into tight engagement with a mating hook shaped bracket 212 which is bolted to an anchor plate 214 which is welded or otherwise attached to the footer plate 108. The hook 210 is a threaded rod which passes through a upright bolt and has its tension adjusted by two tensioning nuts 218 and 220 threaded onto the shaft of the hook.

Returning to the consideration of the FIG. 14, block 201 has a portion which projects straight out from the footer plate and another integral portion which is angled upward. The portion which angles upward attaches to the block 130 by any suitable means such as welding, bolts etc. The block 201 takes the place of the blocks 114 and 116 in the embodiment of FIG. 6 and serves both as a spacer to move the hydraulic cylinders away from the footer plate to give the bursting head space to emerge from the ground as well as to change the angle of the pull by the cylinders so as to give easier access to the cable clamps.

The block 201 also serves as an anchor for an axle 232 (not shown in FIG. 14, but shown in phantom in FIG. 16), around which a pulley 230 (not shown in FIG. 14, but shown in in FIG. 16) turns. The function of the pulley is to transmit the pulling force which is angled upward to a pulling force along the axis of the cable as it exists in the pipe being replaced. The mild upward angle does not put as much stress on the cable as the 90 degree turn upward which was known in the prior art and thus does not cause the cable to break at the pulley.

FIG. 16 is a top closeup view of the improved pulling device showing a sensor setup that can be used on any of the pulling system embodiments to sense to sense the end of the pull stroke and the end of the retract stroke. Although the end of these strokes can be sensed by mechanical microswitches or by monitoring for a pressure rise in the pressurized line when the pistons bottom out in the cylinders in either direction, there are problems with both these approaches. Mechanical microswitches are unreliable and the delicate sensor arms are not well suited to rough and tumble work in the field. The bottoming out approach puts unnecessary stress on the mechanical components of the hydraulic cylinders. Use of proximity sensors 234 and 236 solves both of these problems. Sensors 234 and 236 are placed in grooves formed in block 130 over the path of a tunnel or groove 238 drilled or otherwise formed therein. The tunnel or groove receives a metal rod which is adjustably attached to the hydraulic cylinder head by a block 242. The rod 240 slides back and forth in tunnel 238 as the hydraulic cylinders make pull and retract strokes. When the hydraulic cylinders are fully retracted, the rod is fully pushed into the tunnel and lies under proximity sensors 234 and 236. Both these sensors either close or open an internal switch when they are close to metal. Either closing or opening the switch will suffice as long as the state of the switches in the two sensors is known when the rod is under both sensors in the tunnel. At the end of the pull stroke, the rod is pulled out of the tunnel and does not lie beneath either proximity sensor 234 or 236. This alters the states of the switches in both sensors to known states. The controller on the power pack shown in FIG. 10 can sense the states of the proximity sensors in steps 214 and 224 and cause reversal of the hydraulic pressurization when a pull stroke is complete and when a retract stroke is complete.

All other aspects of the hydraulic pulling arrangement can be the same as in the embodiment of FIG. 6.

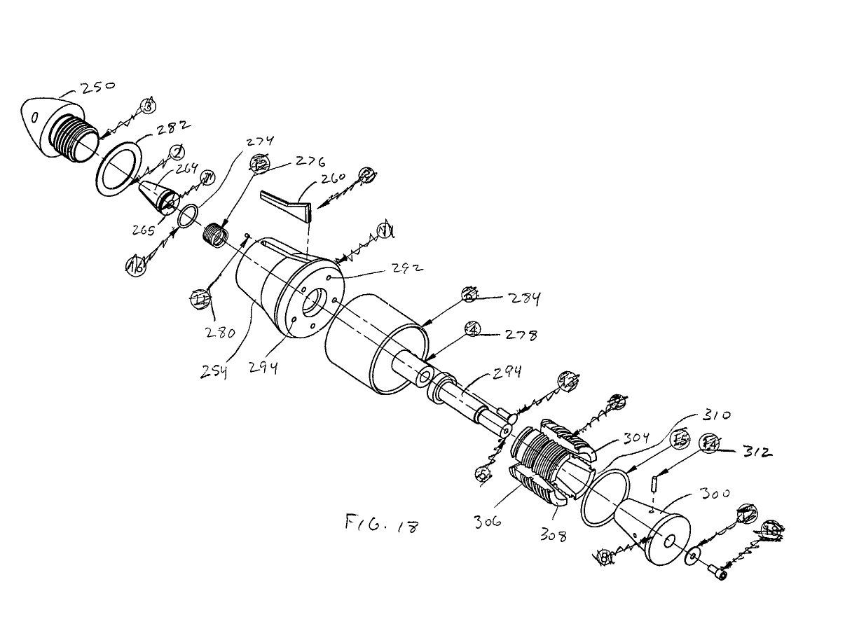

FIG. 17 is a cross-sectional view of an improved bursting head over the prior art bursting head of FIG. 5. FIG. 18 is an exploded view of an alternative embodiment which is very close to the embodiment of FIG. 17. These two embodiments will be discussed in the context of FIG. 17, but most of the discussion also applies to the embodiment of FIG. 18 and parts with the same references numbers in FIG. 18 are the same structure and perform the same function as in the embodiment of FIG. 17.

The bursting head of the invention uses a bullet nose shaped leader cone 250 which serves to lead the bursting head into the pipe to be burst and make sure it does not catch on anything. The leader 250 has a maximum diameter which is smaller than the inside diameter of the pipe to be burst. The leader 250 has a threaded portion 252 which threads into a threaded aperture in a bursting cone 254. This allows the nose piece 250 to be unscrewed from the rest of the bursting head to allow the pulling cable 262 to be disengaged from the head portion 254. Unscrewing the nosepiece 250 also allows insertion of an Allen wrench to engage the large bolt 294 in the embodiment of FIG. 18 or the hex head 296 of the smaller boalt 286 in the embodiment of FIG. 17 so as to unscrew them to release the grip of the gripping dies 304 etc. on the replacement pipe 308.

The bursting cone 254 has a two slope shape which has a slope of only 6 degrees between points 256 and 258. This first slope of 6 degrees give more pipe bursting power with less pull on the cable, but it is only the preferred embodiment. In alternative embodiments, any slope which is substantially more shallow than the slopes found in prior art bursting heads so as to substantially decrease the amount of force needed to pull the bursting cone through the pipe to be replaced will suffice to practice the invention. From point 258 further back toward the replacement pipe 308, the slope increases, but because of the action of the cutting fin 260, the old pipe is burst. This multiple slope shape (there may be more than two slopes and there may be just one more shallow slope than is found in the prior art also) will be referred to as a “complex shaped bursting cone” in the claims even though some species may only have one more shallow slope.

This complex cone shape makes the bursting cone easier to pull through a pipe to be burst as compared to the bursting head of FIG. 5 which has a 12 degree slope in its bursting cone 80. The diameter of the bursting code 254 at point 258 is designed to be sufficiently larger than inside diameter of the pipe to be burst so as to either burst the pipe or substantially stress the pipe by outward expansion. If the pipe does not burst as frequently happens with PVC or other plastic pipes, a cutting fin 260 with a knife edge provides sufficient concentrated stress at the cutting edge to cause the pipe to fracture. The cutting fin is a separate piece which sits in a groove in the bursting head, and is retained there by a set screw 280 in the preferred embodiment, but in alternative embodiments, the cutting fin can be integrally formed as part of the complex shaped bursting head by machining, molding etc,.

The manner in which the cable 262 attaches to the bursting head has also been substantially changed from the prior art bursting head of FIG. 5. In the prior art bursting head of FIG. 5, a cable clevis 91 is permanently swaged onto the end of the cable. This meant that entire cable, starting from the end that did not have the swaged clevis thereon had to be threaded through the nose piece 82. This is a hassle for a long cable and requires that the cable be de-attached from the pulling apparatus.

The cable attachment mechanism has been changed in FIG. 17 to work like Chinese handcuffs such that the harder the cable is pulled upon, the tighter the grip on the cable becomes. This attachment mechanism is implemented by three cammed clamping jaws of which two are visible at 264 and 265. Each jaw has a sloped camming surface such as are shown at 266 and 267. These camming surfaces 266 and 267 which engage camming surfaces 268 and 270 on the inside of the threaded portion 252 of the leader 250. To use this cable attachment mechanism, the plain end of the cable 262 is inserted into hole 272 and threaded into the hole formed by the three clamping jaws. The three clamping jaws are held together by an elastic O-ring 274 so they tend to grab the cable with a weak force. A spring 276 also pushes against the back end of the clamping jaws 264 and 265, and is retained in its position by a spacer/retainer 278. The action of the spring 276 tends to cause the clamping jaws to pinch down on the cable 262 with a weak force. The inside surfaces of the clamping jaws are threaded to give them edges to bite into the cable. When the cable is pulled toward the left of FIG. 17, it also pulls the three clamping jaws forward also. This causes the camming surfaces 264 and 266 to ride on camming surfaces 268 and 270 which tends to push the clamping jaws closer to the centerline of the bursting head thereby causing them to grip the cable 262 tighter.

As the cable is pulled, it tends to want to unwind. The natural tendency of the unwinding of the cable to put forces on the leader 250 which would tend to unscrew it if the threads 252 were right hand threads. For this reason, the threads 252 are left hand threads so that the unwinding of the cable when it is pulled tends to tighten the leader 250 rather than loosen it. A polyethylene washer 282 provides a slippery surface which prevents the leader 250 from becoming jammed against the bursting cone 254.

The back end of the bursting head has a cup 284 bolted on via a bolt 286. In some embodiments, the cup 284 can be permanently attached to the bursting cone 254, but in the preferred embodiment, the cup is removably attached to the bursting cone by one or more bolts. In the preferred embodiment, bolt 286 has an allen wrench inset in the head. Bolt 286 is threaded into a threaded opening 296 of a larger bolt 294 having a threaded end 298. The threaded end 298 thread into a threaded aperture of an expansion cone 300. The expansion cone 300 has a sloped camming surface 302 which engages the inside camming surface 306 of a set of four gripping dies (304, 306, 308 and 310 in FIG. 18). The gripping dies are held together in a circular group so as to engage the camming surface 302 of the expansion cone by a plurality of elastic O-rings of which O-ring 312 is typical. In the preferred embodiment, there are three pairs of O-rings spaced out along the length of the gripping dies to hold them together as a group. A pin 305 engages the gripping dies 304 to prevent them from spinning. In the prior art bursting head designed by inventor Herrick, when the Allen head wrench was turned to loosen the replacement pipe, it would only loosen as long as the dies were touching the pipe. As soon as it was not touching, the dies would spin. By adding pin 305, spin was stopped thereby allowing the dies to collapse completely for an easy removal of the bursting head from the pipe.

The overall function of the cup 284, bolt 286, bolt 294, threads 298, expansion cone 300 and gripping dies 304 etc. is to pinch a replacement pipe 308 between the teeth or threads on the outside surfaces of the gripping dies and the inside of the cup 284 in a chinese handcuff fashion.

To use the pipe engaging mechanism, the bolt 294 is turned so as to move the expansion cone to the right in FIG. 17 thereby allowing the gripping dies to move toward the centerline. This creates a gap between the outside surfaces of the gripping dies and the inside surface of the cub. The new replacement pipe is inserted into this space. The bolt 294 is then turned so as to expand the gripping dies outward to pinch the replacement pipe 308 to the inside surface of the cup.

The orientation of the camming surface 302 and its counterpart on the inside of the gripping dies is such that the harder the pipe 304 resists being pulled into the space where the fractured old pipe was, the tighter the gripping dies grab the pipe. Pins 312 and 314 pass couple the gripping dies to slots or holes in the expansion cone to prevent the expansion cone 300 from spinning when bolt 294 is turned to tighten or loosen the grip.

In an alternative embodiment, shown in FIG. 18, there is no separate bolt 286 threaded into a larger bolt 294. There is only one large bolt 294 with a hex alien wrench inset. The replacement pipe gripping mechanism still works the same way by turning bolt 294 to pinch the replacement pipe against the inside of the cup 284. The cup is held to the bursting cone 254 by bolts (not shown) around the inside of the cup at locations such as 288 and 290 (in FIG. 17) that are threaded into threaded apertures 292, 294 etc. in FIG. 18.

This pipe gripping mechanism is substantially different than the mechanism used in the prior art. In the prior art bursting head shown in FIG. 5, the replacement pipe was welded to a plastic cup that was bolted to the back of the bursting head. More specifically, in FIG. 5, the new pipe 60 is butt welded by suitable cement at butt joint 64 to a plastic cup shaped trailer or “cuff” 62. If this butt weld breaks somewhere in the middle of the pull, it creates a big problem.

Although the invention has been described in terms of the preferred and alternative embodiments, those skilled in the art will appreciate various alternatives that can be implemented without departing from the spirit and scope of the claimed invention. All such variations are intended to be included within the scope of the claims appended hereto.

What is claimed is:

1. A improved bursting head design, comprising:
a truncated complex shaped bursting cone having a left hand threaded opening at the tip and having a shape with at least two different slopes, the slope from said opening back toward the rear of said bursting cone being substantially more shallow than prior art bursting heads;
a cutting fin attached to or formed integrally with said cone shaped body;
a leader having an opening therethrough big enough to allow a pulling cable to pass therethrough and having a left hand threaded projecting portion which engages said left handed threaded opening of said bursting cone, and having a sloped inside camming surface;
cable clamping means which engage said camming surface of said leader, for allowing a cable to be inserted into said bursting cone through said opening in said leader and for gripping said cable at a point inside said projecting portion of said leader in such a manner that when said cable is pulled, said grip becomes tighter; and
replacement pipe gripping means permanently or partially permanently or removably attached to said bursting cone, for allowing a replacement pipe to be slit into said replacement pipe gripping means and for allowing the pipe to be gripped with a grip which increases as said replacement pipe is pulled in a direction to tend to disengage it from said replacement pipe gripping means.
